(19) United States
(12) Patent Application Publication
(10) Pub. No.: US 2017/0011475 A1
(43) Pub. Date: Jan. 12, 2017

(54) MOBILE SPIRITS NOTIFICATION APPLICATION AND PURCHASING SYSTEM

(71) Applicant: Christian Alfred Landsberger Glik, Key Biscayne, FL (US)

(72) Inventor: Christian Alfred Landsberger Glik, Key Biscayne, FL (US)

(21) Appl. No.: 14/793,739

(22) Filed: Jul. 8, 2015

(51) Int. Cl. G06Q 50/12; G06Q 30/06; H04W 88/02

(52) U.S. Cl. CPC G06Q 50/12; H04W 88/02; G06Q 30/0633

(57) ABSTRACT

A manager manipulates a local computer station or mobile device having management application software thereon; entering a message relating to specials, services and events the manager utilizes the management computer of to transmit parameter based messages to local users of mobile devices and to local display devices. A mobile patron user purchases tokens from a payment processor and uses these tokens to purchase specials, drinks or to get extra services such as ticketing, VIP or event related information and specials.

### FIELD OF THE INVENTION

This invention relates to improvements to mobile application software and or firmware located on smartphones, cellular phones, PDA devices and similar electronic architectures. More particularly, this invention relates to an application involved with the current pricing and availability of alcoholic beverages at various locales.

### BACKGROUND OF THE INVENTION

Commerce Related Mobile Systems on the Market: There are many ways currently on the market relating to the purchasing of products using a mobile phone or the transfer of money from one person or group to another. Amongst some of these are:

1—Mobile Money Transfer; 2—Mobile ATM; 3—Mobile ticketing; 4—Mobile vouchers, coupons and loyalty cards; 5—Content purchase and delivery; 6—Location-based services; 7—Information services; 8—Mobile Banking; 9—Mobile brokerage; 10—Auctions; 11—Mobile browsing; 12—Mobile purchase; 13—Mobile marketing and advertising; 14—In-application mobile phone payments.

This application based payment method permits the processing of payments directly within a mobile app loaded onto a smartphone memory using an operating system such as android or the ubiquitous iOS of Apple computer. In-app purchases can be used to buy virtual goods, new and other mobile content and is ultimately billed by mobile carriers rather than the app stores themselves. Other forms of payment include the Paypal Application and similar applications that permit purchasing using the Paypal web gateway; Paypal has expanded its service to provide users with a credit card reader having an interface that is attached to a port on the side of the smartphone. Others such as Square have followed suit with this technique.

Food & Wine Mobile Applications: All of these mechanisms are utilized by individuals to purchase a plethora of consumer and business goods and services. It is to be expected that with all of this effort most users would find time to relax and enjoy the various options in food and wine that have been made available with the new technology. Not to disappoint various applications have been created to enhance the knowledge of food and wine. Amongst these are:

1—Food & Wine Cocktail App for iPhone and Android: this app features recipes for more than 350 outstanding drinks by America's best mixologists, and according to the creators thereof: great party food, essential cocktail-making tips, a comprehensive spirits guide and a definitive listing of America's top 100 bars and lounges.

2—Best New Chefs App: this application promises to provide you with information on the best restaurants and chefs by the editors of FOOD & WINE magazine. Each year, the ten best new chefs are honored as those best representing the emerging talent in the culinary world. The Best New Chef award has unveiled some of the visionary geniuses shaping the epicurean world. A compilation of data spanning many years, the comprehensive iPhone application includes an extensive library of each chef's restaurants.

3—Wine App for Android: Many wine apps are available for the android operating system. Typical amongst these are the Vivino Wine Scanner. This application permits its users to snap a label shot and use the image to look up the wine's tech sheets, ratings, winemaker's notes and more. Tracking your favorite wines and sharing them with friends has never been easier. Of course, there are other applications similar to the aforementioned out there.

Finally, an exchange bar and grills has a scrolling ticker on a television device having fluctuating drink prices placed thereon for patron review. See for example, http:// www.odditycentral.com/travel/the-exchange-bar-grill-where-prices-fluctuate-like-stocks.html. At the Exchange Bar & Grill in New York City, prices of food and drink fluctuate according to the law of supply and demand. The prices for your favorite drinks fluctuate depending on supply and demand. Watch a while when no one is ordering your favorite drink and snag it when the cost falls to unbelievable lows—or use your leverage to jack up the price of any cocktail, drink or shot for the whole bar. The ‘ticker tape’ flashes the fluctuating menu prices in red lettering according to an software algorithm.

However, none of these or any other currently on the market or available as freeware or shareware provides users with an easy on the fly mobile purchasing mechanism.

Accordingly, there needs to be some solution to overcome the aforementioned problems.

### SUMMARY OF THE INVENTION

The present invention overcomes the deficiencies of the known art and the problems that remain unsolved as shown in the accompanying embodiments.

An alcohol management system comprising:
a lounge management computer having
   a lounge management application software loaded into
   a memory of the management computer and
   an antenna connected thereto.

In another aspect,
a mobile device having
   an antenna integrated therein and
   a user application software loaded into
   a memory of the mobile device wherein the user management application software corresponds to the lounge management application software.

In another aspect,
a display device having
   a connection device such that the display device is connected to the lounge management computer.

In another aspect, wherein the connection device is a wireless connection.

In another aspect, wherein the connection device is a wired connection.

In another aspect, wherein the lounge management application software further comprises:
an alcohol message software device and
a transmission and reception software device.

In another aspect, wherein the lounge management application software further comprises:
a factor message software device and
a transmission and reception software device.

In another aspect, wherein the user application software further comprises:
a display software device
a purchasing software device and
a transmission and reception software device.

A method of controlling and managing an alcohol selling establishment comprising the steps of:
monitoring parameters based on the establishment and storing the aforementioned on a management computer system having a management application software
creating a parameter related message called a factor on a management computer system and
transmitting the message to another device.

In another aspect,
wherein the factor is a special or deal relating to liquor.

In another aspect,
wherein the factor is a VIP service.

In another aspect,
wherein the factor is an event related information or transaction.

In another aspect,
wherein the factor is an event related transaction.

In another aspect,
receiving the message at a user device.

In another aspect,
purchasing an alcohol item using a previously purchased token.

In another aspect,
wherein the alcohol item is from the group consisting of: liquor, beer, and spirits.

In another aspect, wherein the other device is a mobile device.

In another aspect, wherein the other device is a display device.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 represents a system level diagram of various features of a Mobile Spirits Notification Application and Purchasing System as taught in an embodiment herein.

FIG. 2 shows a flowchart diagram of various steps in a process of using the Mobile

Spirits Notification Application and Purchasing System as taught in an embodiment herein.

FIG. 3 illustrates a flowchart diagram of various steps in a process of purchasing credits in the Mobile Spirits Notification Application and Purchasing System as taught in an embodiment.

FIG. 4 illustrates a process used by a merchant for offering specials and or deals to mobile user devices using a Mobile Spirits Notification Application and Purchasing System as taught in an embodiment.

FIG. 5 illustrates a process used by a merchant for transmitting messages about services using Mobile Spirits Notification Application and Purchasing System as taught in an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The following embodiments teach a system and several processes involved in the creation and operation of a Mobile Spirits Notification Application and Purchasing System.

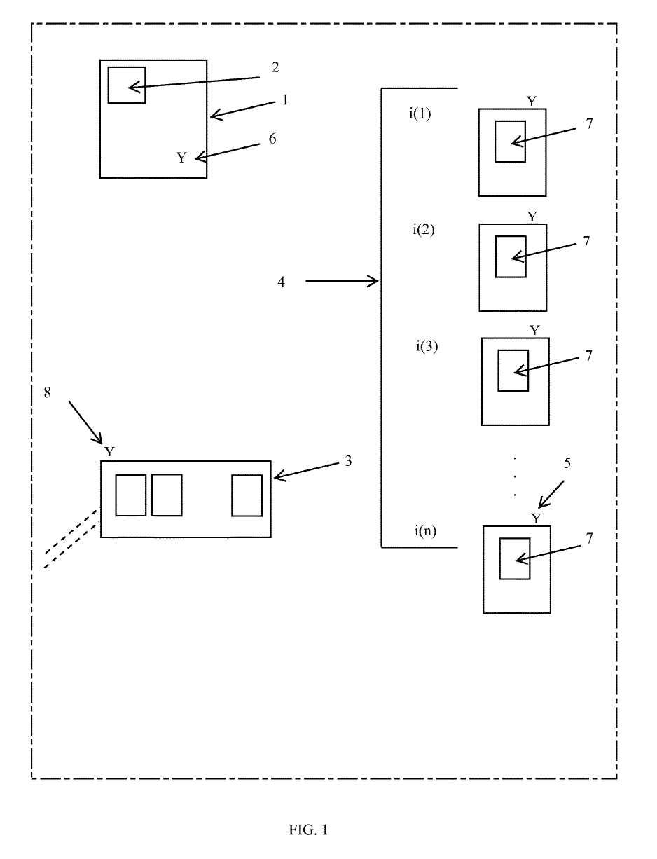

FIG. 1 represents a system level diagram of various features of a Mobile Spirits

Notification Application and Purchasing System as taught in an embodiment herein. A bar or restaurant server, computer or mobile device 1, has a loaded piece of software 2 and antenna 6 that is used to communicate wirelessly (wifi, NFC, bluetooth, regular wireless phone communication) to various mobile devices 4 i(1), i(2), i(3), . . . i(n) that have mobile antenna 5; these mobile devices are typically smartphones, pdas, or other computer devices that can support this type of notification system. The software 2 is written so as to transmit information relevant to various locally provided beer, liquor, and or wine deals, specials, availability as well as various other types of parameters relating to the establishment being visited. For example, a bar or restaurant may want to transmit the current dress code, provide a button on a mobile page for purchasing a VIP pass and or provide a suggestion and or complaint form for mobile user devices i(1), i(2), i(3), . . . i(n). Users need only buy credits in the system

Each of the mobile devices i(1), i(2), i(3), . . . i(n) has an antenna 5 to communicate with the bar or restaurant server, computer or mobile device 1 using an antenna 6 thereof. Also, a mobile application 7 is stored on a local memory device of the mobile devices i(1), i(2), i(3), . . . i(n). This application provides all the necessary parameters and transmission reception variables utilized in communicating with the bar or restaurant server, computer or mobile device 1 and its associated software 2.

Finally, a LED display 3 is controlled by a local micro-controller having having a wireless (antenna) or wired connection 8 to the bar or restaurant server, computer or mobile device 1. This facilitates the presentation of specials, deals and other information on a ticker tape type display at one or more convenient locations in the bar or restaurant. Further, the displays can be located up on a wall or on each table in a plastic centerpiece or integrated with the surface of the table.

A bar or restaurant server, computer or mobile device 1 is manipulated by a user thereof to push data using the application software 2 across a wired connection or wireless connection 8. The data is received at the micro-controller of the LED display and presented to the user so as to present a special. In the example shown, WHIS 2:1 indicates that WHISKEY is available for a 2:1 special; the price is optionally later displayed. It should be understood that the software application 2 presents a series of menu and text boxes whose results are transmitted to the display and or mobile devices i(1), i(2), i(3), . . . i(n) for interpretation. As an example, the menus would provide a prearranged messages 3:1, 2:1, Whiskey, WHIS, RUM, BEER, Lite BEER, SHOTS, DRESS CODE, VIP services and similar messages. The free format text box entries would provide ability at the application 2 to provide alternatives to customers on the fly.

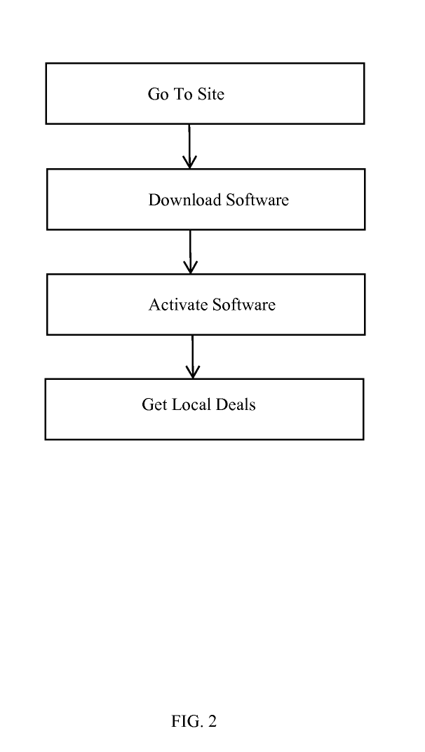

FIG. 2 shows a flowchart diagram of various steps in a process of using the Mobile

Spirits Notification Application and Purchasing System as taught in an embodiment herein. First, a user of a mobile device i(1), i(2), i(3), . . . i(n) navigates over to a site having the application software 7 and downloads it either as freeware, shareware or for full payment. Once loaded onto the mobile devices i(1), i(2), i(3), . . . i(n) a user can open up his or her applications pane having the application therein. He or she then activates the application 11 thereby informing the onboard processor of the one mobile device to engage the application process. Once activated, the mobile, WIFI or BLUETOOTH signal provides data information relating to any local deals 12 or information in the neighborhood about the mobile device. This is presented in a list or menu format such that a user can scroll through these and activate any links provided to the bar or restaurant where the user is located or bar or restaurant nearby.

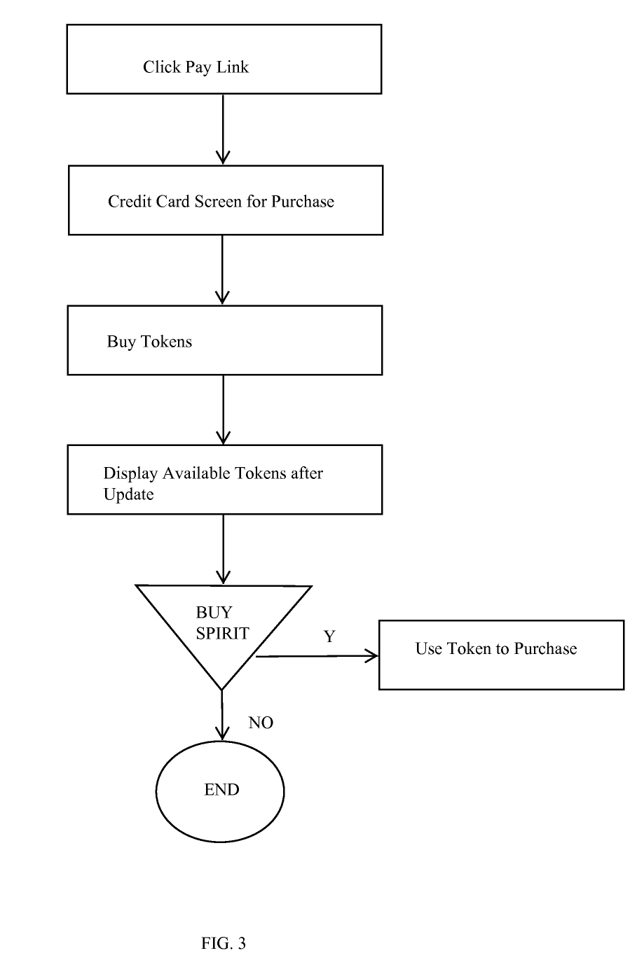

FIG. 3 illustrates a flowchart diagram of various steps in a process of purchasing credits in the Mobile Spirits Notification Application and Purchasing System as taught in an embodiment. To gain the benefit of the deal a user can buy tokens or credits in the system by paying for it using his local application 7; thus, to get the process started he or she activates the application software 7. A pay link is provided on the mobile device in the form of an icon that a user clicks. Once clicked the application presents a credit card entry screen to the user at his mobile device screen whereby a user provides the necessary information to get a credit card purchase for a user selected number of tokens. To secure the transaction, either before the credit card entry screen is presented or after the information is entered into the mobile device but before data transmission, an encrypted session is created between the mobile device and a payment processor.

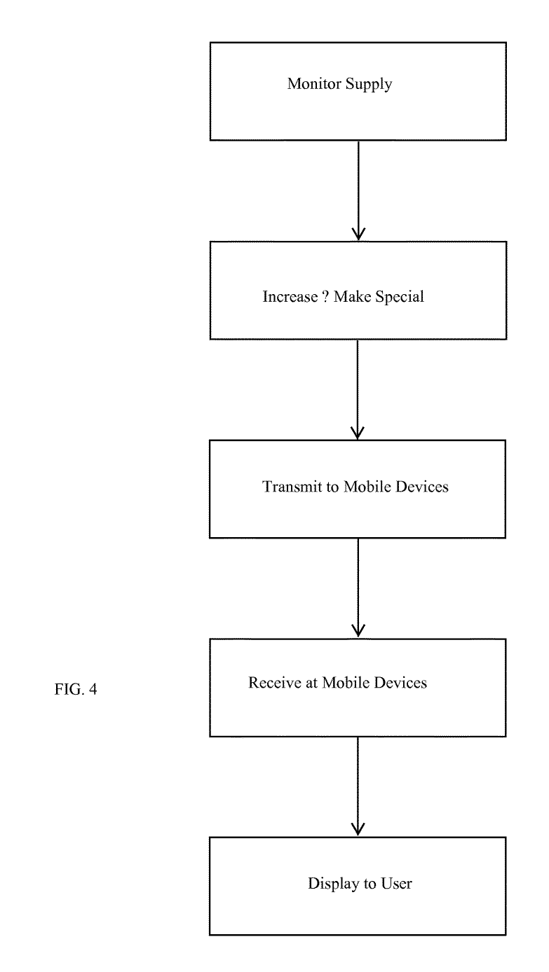

This payment processor keeps a record of the number of tokens that a user has on record and that can be presented to the user as required; additionally, this session transacts the credit or token purchase and updates a mobile device i(1), i(2), i(3), . . . i(n) local display of the number of available tokens. To facilitate the user choosing the amount of tokens he or she wants, there is a user entry text box or check box presented to the user having a predetermined amounts of credits or tokens. He then selects this amount to purchase with a credit or debit card. The tokens available on his account are updated on his or her display and a list of available items is presented. A similar menu system (menu, checkboxes, credit, debit) is presented and used by a user to select the amount of liquor, spirits or beer that he or she wants and completes the transaction that is later approved by the payment processor (likewise for specials, deals or other factors offered by the establishment in FIGS. 4 & 5 below). In this case however, the user choice of beer, wine, spirits or other factors is retransmitted back to the bar computer 1 and displayed to the bar representative for delivery of the goods and or services.

FIG. 4 illustrates a process used by a merchant for offering specials and or deals using Mobile Spirits Notification Application and Purchasing System as taught in an embodiment. A merchant user having access and control of the bar or restaurant server, computer or mobile device 1 monitors 20 the supply of liquor, spirits or beer in his establishment. When he finds that there is an increase in supply 21 of a particular liquor, spirit or beer he may want to establish a deal or special for users so as to reduce the amount of oversupply or increase. He does this by manipulating a menu or text entry interface found on the bar or restaurant server, computer or mobile device 1 thereby entering information 22 representing the deal he clicks an actuation button using his mouse, keyboard or touch screen display.

At this point the application software 2 transmits 23 the data special to mobile devices i(1), i(2), i(3) . . . i(n) using a wireless antenna (Bluetooth, WIFI, NFC, regular mobile communication via mobile network) 6 and or to LED display 3 24. The processor onboard each mobile device using local application software and or the micro-controller (not shown) on each LED device receives the command and interprets it so as to present a graphical indicator 25 in the form of a button, blinking light or other signature to inform users of mobile devices i(1), i(2), i(3) . . . i(n) about the special or other information; similarly the information is received in the LED micro-controller causing it to command the lighting up of the correct LEDs thereon; this actuates the display illuminating the special message to local users.

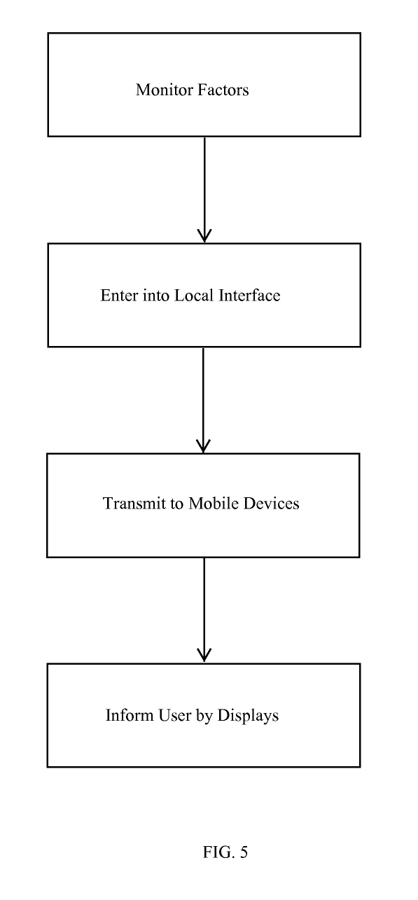

FIG. 5 illustrates a process used by a merchant for transmitting messages about services using Mobile Spirits Notification Application and Purchasing System as taught in an embodiment. A merchant user having access and control of the bar or restaurant server, computer or mobile device 1 monitors 30 various events, VIP service availability, ticket handling and other factors relating to his or her establishment. When he finds that there is a need or desire to communicate information to a user about the aforementioned he or she may want to send this data to nearby mobile users or ping a general message throughout his establishment using the display devices 3. He does this by manipulating a menu or text entry interface found on the bar or restaurant server, computer or mobile device 1 thereby entering information 31 representing the relevant information as he clicks an actuation button using his mouse, keyboard or touch screen display.

At this point the application software 2 transmits 32 the data special to mobile devices i(1), i(2), i(3) . . . i(n) using a wireless antenna (Bluetooth, WIFI, NFC, mobile network) 6 and or to LED 3 display. The processor onboard each mobile device and or the micro-controller (not shown) on each LED device receives the command 33 and interprets using application software it so as to present a graphical indicator 34 in the form of a button, blinking light or other signature to inform users of mobile devices i(1), i(2), i(3) . . . i(n) about the factor or other information; similarly the information is received in the LED micro-controller causing it to command the lighting up of the correct LEDs thereon; this actuates the display illuminating the establishment factor message to local users.

A location dependent alcoholic beverage application 7 represented as a specific icon on the computing device brings up information (Name, types of drinks offered, address, phone, hours and more) relating to nearby establishments using GPS, wifi, internet or other location searching devices; highlighting, blinking, colored, sticker marked (yellow blue icon; all this for specials, events etc) or other means of accentuating a particular link are provided within the application 7. A user can click on these links by selecting one that opens up a menu; this menu has a list of choices selectively available and a scrolling horizontal ticker at the top thereof that describes what deals are available therein; the ticker can optionally be loaded vertically or both ways. This scrolling price ticker is shown in the window of the mobile devices application 7 such that fluctuating rates of beverages are representable in real time as they are updated by local businesses.

Therefore, it is intended that the invention not be limited to the particular embodiments disclosed for carrying out this invention, but that the invention will include all the embodiments falling within the scope of the appended claims. cm What is claimed is:

1. An alcohol management system comprising:
a lounge management computer having
a lounge management application software loaded into
a memory of the management computer and
an antenna connected thereto.

2. The alcohol management system of claim 1, further comprising:
a mobile device having
an antenna integrated therein and
a user application software loaded into
a memory of the mobile device wherein the user management application software corresponds to the lounge management application software.

3. The alcohol management system of claim 1, further comprising:
a display device having
a connection device such that the display device is connected to the lounge management computer.

4. The alcohol management system of claim 3, wherein the connection device is a wireless connection.

5. The alcohol management system of claim 3, wherein the connection device is a wired connection.

6. The alcohol management system of claim 1, wherein the lounge management application software further comprises:
an alcohol message software device and
a transmission and reception software device.

7. The alcohol management system of claim 1, wherein the lounge management application software further comprises:
a factor message software device and
a transmission and reception software device.

8. The alcohol management system of claim 1, wherein the user application software further comprises:
a display software device
a purchasing software device and
a transmission and reception software device.

9. A method of purchasing alcohol comprising the steps of:
loading an application onto a mobile device and
activating the application
receiving messages from local establishments and
buying a token from a liquor exchange payment processor.

10. The method of purchasing alcohol of claim 9, further comprising the steps of:
clicking a purchasing symbol on the mobile device and thereby purchasing liquor.

11. A method of controlling and managing an alcohol selling establishment comprising the steps of:
monitoring parameters based on the establishment and storing the aforementioned on a management computer system having a management application software
creating a parameter related message called a factor on a management computer system and
transmitting the message to another device.

12. The method of controlling and managing an alcohol selling establishment of claim 11, wherein the factor is a special or deal relating to liquor.

13. The method of controlling and managing an alcohol selling establishment of claim 11, wherein the factor is a VIP service.

14. The method of controlling and managing an alcohol selling establishment of claim 11, wherein the factor is an event related information or transaction.

15. The method of controlling and managing an alcohol selling establishment of claim 11, wherein the factor is an event related transaction.

16. The method of controlling and managing an alcohol selling establishment of claim 11, further comprising the step of:
receiving the message at a user device.

17. The method of controlling and managing an alcohol selling establishment of claim 16, further comprising the step of:
purchasing an alcohol item using a previously purchased token.

18. The method of controlling and managing an alcohol selling establishment of claim 17, wherein the alcohol item is from the group consisting of: liquor, beer, and spirits.

19. The method of controlling and managing an alcohol selling establishment of claim 11, wherein the other device is a mobile device.

20. The method of controlling and managing an alcohol selling establishment of claim 11, wherein the other device is a display device.
